(19) United States
(12) Patent Application Publication
(10) Pub. No.: US 2013/0176731 A1
(43) Pub. Date: Jul. 11, 2013

(54) LED Lamp

(71) Applicant: Wen-Lung Chin, New Taipei City (TW)

(72) Inventor: Wen-Lung Chin, New Taipei City (TW)

(21) Appl. No.: 13/344,659

(22) Filed: Jan. 6, 2012

(51) Int. Cl. F21V 15/01; F21V 29/00

(52) U.S. Cl. 362/249.02

(57) ABSTRACT

An LED lamp includes a housing, a base plate combined with the housing, and a plurality of LED crystals combined with the base plate. The LED crystals are connected serially, and a total allowable voltage of the LED crystals is equal to or greater than a voltage of an external power supply. The base plate is integrally combined with the housing completely by injection molding so that the base plate and the housing are combined closely and solidly and will not detach from each other. In addition, the LED lamp does not need provision of a drive device.

### BACKGROUND OF THE INVENTION

1. Field of the Invention

The present invention relates to a lighting appliance and, more particularly, to an LED (light emitting diode) lamp.

2. Description of the Related Art

A conventional LED (light emitting diode) lamp comprises a housing, and a base plate combined with the housing. The base plate is combined with an LED module (which is a modularized product) so that the base plate and the LED module are packed to function as an LED light source. Alternatively, the base plate is combined with at least one LED crystal so that the base plate and the LED crystal are packed to function as an LED light source. The base plate and the housing are made of two different materials. The base plate has a plurality of screw holes, and the housing has a plurality of screw bores which are connected with the screw holes of the base plate by a plurality of screw members (such as screws and the like) so that the base plate is combined with the housing by screwing. However, the base plate is not combined with the housing closely and tightly by screwing, thereby decreasing the structural strength of the LED lamp. Alternatively, the base plate is combined with the housing by a bonding agent, such as a gel and the like. However, the bonding agent is located between the base plate and the housing, thereby decreasing the heat conducting effect of the LED lamp. In addition, the LED lamp is driven by a direct current so that the LED lamp needs to provide a drive device to convert an alternating current of an external power supply into the direct current. The drive device includes a bridge rectifier, a filter circuit, a transformer circuit, a feedback circuit and the like, so that the drive device has a complicated construction, thereby increasing the cost of fabrication, and thereby decreasing the lifetime of the LED lamp.

### BRIEF SUMMARY OF THE INVENTION

In accordance with the present invention, there is provided an LED lamp, comprising a housing, a base plate combined with the housing, and a plurality of LED crystals combined with the base plate. The LED crystals are connected serially, and a total allowable voltage of the LED crystals is equal to or greater than a voltage of an external power supply.

Preferably, the base plate and the crystals are packed to function as an LED light source.

Preferably, the base plate is integrally combined with the housing by injection molding.

Preferably, the base plate is made of a metal having great heat conductivity and great heat dissipation.

Preferably, the base plate is made of a porous nonmetallic material with great heat conduction and great heat dissipation.

Preferably, the housing is made of a plastic material.

Preferably, the housing is made of a porous nonmetallic material with great heat conduction and great heat dissipation.

Preferably, the LED lamp further comprises a heatsink module combined with the housing. The heatsink module is integrally combined with the housing by injection molding. The base plate, the housing and the heatsink module are integrally combined together by injection molding. The heatsink module is located under the base plate and has a top face abutting a bottom face of the base plate.

The primary objective of the present invention is to provide an LED lamp having a better structural strength.

According to the primary advantage of the present invention, the base plate is integrally combined with the housing completely by injection molding so that the base plate and the housing are combined closely and solidly and will not detach from each other so as to enhance the structural strength of the LED lamp.

According to another advantage of the present invention, the base plate and the housing are combined closely so as to enhance the heat conducting effect of the LED lamp.

According to a further advantage of the present invention, the LED lamp does not need provision of a drive device, thereby decreasing the cost of fabrication, and thereby enhancing the lifetime of the LED lamp.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front cross-sectional assembly view of an LED lamp in accordance with the preferred embodiment of the present invention.

### DETAILED DESCRIPTION OF THE INVENTION

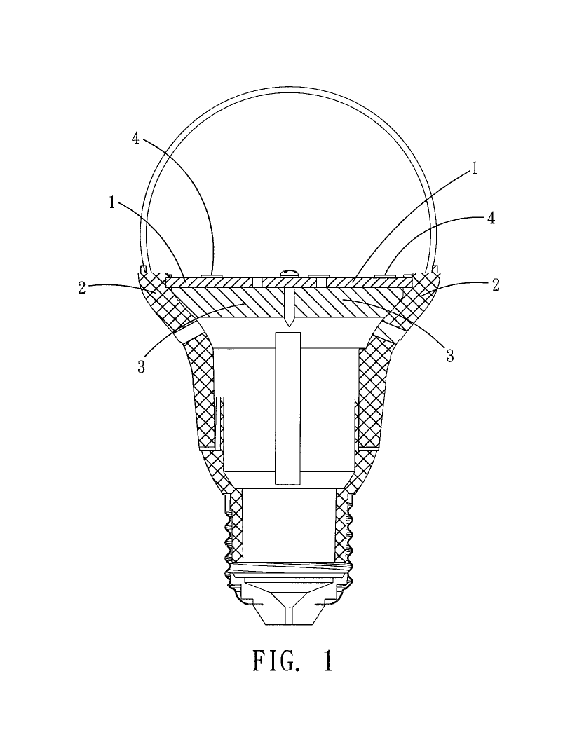

Referring to FIG. 1, an LED (light emitting diode) lamp in accordance with the preferred embodiment of the present invention comprises a housing 2, a base plate 1 combined with the housing 2, and a plurality of LED crystals 4 combined with the base plate 1.

The LED crystals 4 are connected serially, and a total allowable voltage of the LED crystals 4 is equal to or greater than a voltage of an external power supply. In general, the voltage of the external power supply is equal to 110V or 220V, and the total allowable voltage of the LED crystals 4 is equal to or greater than 110V or 220V. Thus, the LED lamp does not need provision of a drive device, thereby decreasing the cost of fabrication, and thereby enhancing the lifetime of the LED lamp.

The base plate 1 and the crystals 4 are packed to function as an LED light source. The base plate 1 is integrally combined with the housing 2 by injection molding. Thus, the base plate 1 is integrally combined with the housing 2 by plastic injection molding so that the base plate 1 and the housing 2 are combined closely and solidly and will not detach from each other so as to enhance the structural strength of the LED lamp.

In the preferred embodiment of the present invention, the base plate 1 is made of a metal having great heat conductivity and great heat dissipation, such as gold, silver, copper, iron, aluminum, cobalt, nickel, zinc, titanium, manganese and the like. Alternatively, the base plate 1 is made of a porous nonmetallic material with great heat conduction and great heat dissipation. The porous nonmetallic material of the base plate 1 is made of a nonmetallic powder having a great heat conductivity, such as Al₂O₃, Zr₂O, AlN, SiN, BN, WC, SiC, C, crystalline SiC, Recrystalline SiC (ReSiC) and the like. Preferably, the nonmetallic powder of the base plate 1 is selected by AlN and SiC.

In the preferred embodiment of the present invention, the housing 2 is made of a plastic material. Alternatively, the housing 2 is made of a porous nonmetallic material with great heat conduction and great heat dissipation. The porous nonmetallic material of the housing 2 is made of a nonmetallic powder having a great heat conductivity, such as Al₂O₃, Zr₂O, AlN, SiN, BN, WC, SiC, C, crystalline SiC, Recrystalline SiC (ReSiC) and the like. Preferably, the nonmetallic powder of the base plate 1 is selected by AlN and SiC.

In the preferred embodiment of the present invention, the LED lamp further comprises a heatsink module 3 combined with the housing 2. The heatsink module 3 is integrally combined with the housing 2 by injection molding. Thus, the base plate 1, the housing 2 and the heatsink module 3 are integrally combined together by injection molding. The heatsink module 3 is located under the base plate 1 and has a top face abutting a bottom face of the base plate 1 to enhance the heatsink effect of the base plate 1.

In the preferred embodiment of the present invention, the housing 2 has an end portion provided with a threaded stud for mounting a metallic screw base, an insulating gasket and a power contact plate. Preferably, each of the metallic screw base, the insulating gasket and the power contact plate has an international specification of E-27, E-14 and the like so that the housing 2 is available for a conventional electric bulb.

Alternatively, the housing 2 is provided with two connecting pins (with an international specification of MR16 and the like) so that the housing 2 is available for a conventional projection lamp.

Accordingly, the base plate 1 is integrally combined with the housing 2 completely by injection molding so that the base plate 1 and the housing 2 are combined closely and solidly and will not detach from each other so as to enhance the structural strength of the LED lamp. In addition, the base plate 1 and the housing 2 are combined closely so as to enhance the heat conducting effect of the LED lamp.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An LED lamp, comprising:
a housing;
a base plate combined with the housing; and
a plurality of LED crystals combined with the base plate;
wherein the LED crystals are connected serially; and
a total allowable voltage of the LED crystals is equal to or greater than a voltage of an external power supply.

2. The LED lamp of claim 1, wherein the base plate and the crystals are packed to function as an LED light source.

3. The LED lamp of claim 1, wherein the base plate is integrally combined with the housing by injection molding.

4. The LED lamp of claim 1, wherein the base plate is made of a metal having great heat conductivity and great heat dissipation.

5. The LED lamp of claim 1, wherein the base plate is made of a porous nonmetallic material with great heat conduction and great heat dissipation.

6. The LED lamp of claim 1, wherein the housing is made of a plastic material.

7. The LED lamp of claim 1, wherein the housing is made of a porous nonmetallic material with great heat conduction and great heat dissipation.

8. The LED lamp of claim 1, wherein the LED lamp further comprises a heatsink module combined with the housing.

9. The LED lamp of claim 8, wherein the heatsink module is integrally combined with the housing by injection molding.

10. The LED lamp of claim 8, wherein the base plate, the housing and the heatsink module are integrally combined together by injection molding.

11. The LED lamp of claim 8, wherein the heatsink module is located under the base plate and has a top face abutting a bottom face of the base plate.
